(19) United States
(12) Patent Application Publication
(10) Pub. No.: US 2017/0046513 A1
(43) Pub. Date: Feb. 16, 2017

(54) FIRMWARE AUTHENTICATION

(71) Applicant: HEWLETT PACKARD ENTERPRISE DEVELOPMENT LP, Houston, TX (US)

(72) Inventor: Brandon McGovern, Palo Alto, CA (US)

(21) Appl. No.: 15/114,101

(22) PCT Filed: Dec. 16, 2013
(86) PCT No.: PCT/US2013/075395

§ 371 Date: Jul. 26, 2016

(51) Int. Cl. G06F 21/57; G06F 9/445; G06F 21/44

(52) U.S. Cl. CPC G06F 21/572; G06F 21/44; G06F 8/65; G06F 2221/033

(57) ABSTRACT

Techniques for updating a firmware on a firmware directed processing element are provided. In one aspect, a firmware image may be received at a firmware directed processing element. The firmware image may include firmware image authentication information. The firmware image authentication information may be forwarded to a second processing element. An indication may be received from the second processing element indicating the authenticity of the firmware image.

### BACKGROUND

Modern computing systems include many components that may be provided by numerous vendors. For example, a modern computer system may include processors, network switches, baseboard management controllers, IO controllers, network interface cards, and any number of other types of components. Each of these components may utilize firmware. Firmware is generally software that is executable by the component and is tightly coupled to the component. For example, the firmware may be the instructions that translate general purpose instructions from an operating system into component specific instructions that are to be executed by the hardware.

### BRIEF DESCRIPTION OF THE DRAWINGS

FIG. 1 is an example of a system that may utilize the firmware authentication techniques described herein.

FIG. 2 is another example of a system that may utilize the firmware authentication techniques described herein.

FIG. 3 is an example of a high level flow diagram for authenticating a firmware image in accordance with the techniques described herein.

FIG. 4 is another example of a high level flow diagram for authenticating a firmware image in accordance with the techniques described herein.

FIG. 5 is an example of a high level flow diagram for authenticating a firmware image according to techniques described herein.

FIG. 6 is another example of a high level flow diagram for authenticating a firmware image according to techniques described herein.

### DETAILED DESCRIPTION

From time to time, it may be desirable to update the firmware for a particular component. Firmware updates may provide the component with additional capabilities. In some cases, firmware updates may be used to correct errors, often referred to as bugs, that may exist on previous versions of the firmware. Regardless of the reason for the firmware update, it should be understood that in many cases, the firmware that operates on a component is capable of being updated.

As mentioned above, firmware is tightly coupled with its associated hardware. As such, the firmware may have unrestricted control of the hardware. In some cases, it may be possible that improper firmware may actually damage the hardware. In addition, firmware may operate at a lower level than operating systems or applications, thus bypassing security features. For example, a firmware may bypass an operating systems virus and malware scanning procedures.

As should be clear, firmware may have a great degree of control over hardware and the system in general. As such, it may be important to ensure that the firmware that is loaded onto a component is authorized to be run on the component. For example, a vendor of a particular component may want to ensure that only firmware provided by the vendor is able to run on the component. To achieve this goal, code signing algorithms may be used. Upon creation of a firmware update, the creator may sign the update. Although many techniques for code signing are available, the process generally involves using mathematical algorithms, such as cryptographic hash functions, to create a signature for the code. The signature may then be used for later authentication of the code, as described below.

When a component is to be updated with the newly created firmware, the firmware may first be downloaded to the component. The component itself may then authenticate the downloaded image using the signature. Essentially an algorithm corresponding to the algorithm that was originally used to sign the firmware image is run on the firmware image, and is compared to the signatures. If the results match, it may be concluded that the firmware is authentic, as it came from the vendor. This is because if it were not authentic, the authentication functions on the component would not have computed the proper signature.

Although code signing techniques are able to ensure that a firmware image is authentic, a problem arises in cases where the code signing techniques cannot be implemented on a component. For example, in many cases, the mathematical algorithms that are used as part of the code signing process are associated with governmental restrictions related to the export of those algorithms. For example, a vendor of server computers may use components sourced from many different countries. If government regulations prohibit the code signing algorithm from being exported to the countries from which those components are sourced, it is not possible for the component to implement the code signing authentication process. As such, the component is vulnerable to having un-authenticated firmware installed. For purposes of this description, a code signing algorithm being prohibited on a component means that the component is not authorized to run the algorithm. This may be due to government regulations or some other reason. The specific reason for the prohibition is unimportant.

The techniques described herein overcome these problems by delegating the firmware authentication procedure from a first component that is prohibited for executing the code singing authentication process to another component in the system that is authorized to authenticate the firmware image. The prohibited component may send information associated with a newly received firmware image that can be used to authenticate the firmware image to a second component. The second component may then determine is the firmware image is authentic by executing the code signing authentication process. If the firmware is authentic, an indication may be sent to the first component, indicating that the firmware is authentic can be safely executed. Otherwise, the component may receive an indication that the firmware is not authentic and may take corrective action, such as deleting the firmware image. The techniques are described in further detail below and in conjunction with the appended figures.

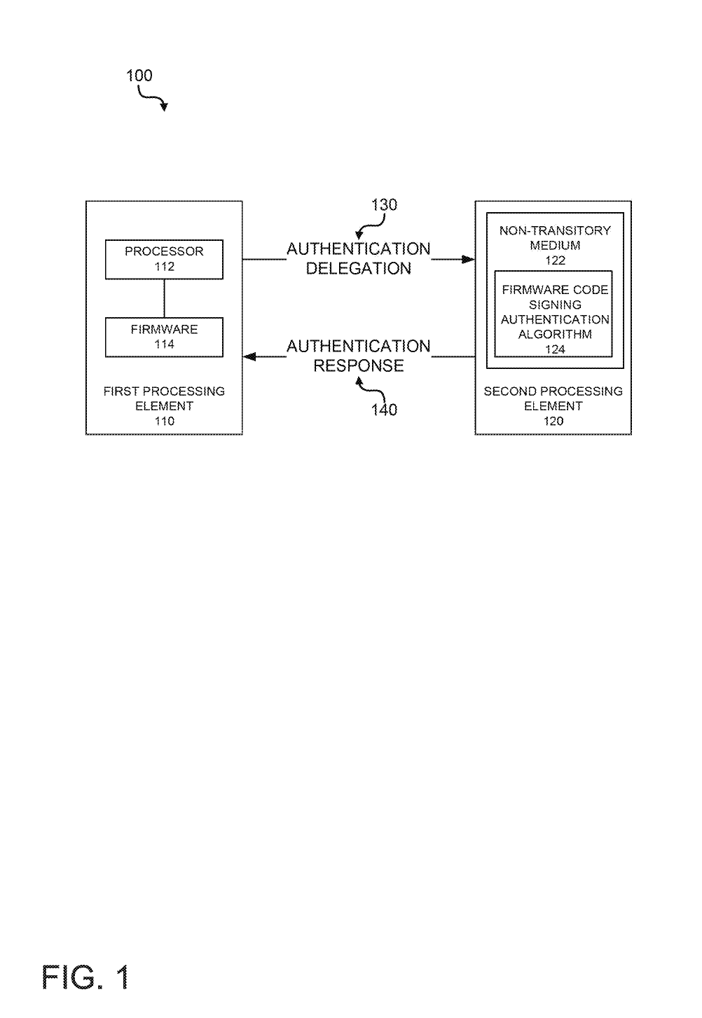

FIG. 1 is an example of a system that may utilize the firmware authentication techniques described herein. System 100 may include a first processing element 110 coupled to a second processing element 120. The two processing elements may be coupled via any number of communications channels (not shown). For example, the communications channel may be a direct wired communications channel, a network, wireless, or any other mechanism that provides for communications between the two processing nodes. The specific mechanism is unimportant and may vary depending on the implementation. The techniques described herein are not limited to any communications mechanism.

First processing element 110 may include a processor 112 and firmware 114. The processor may be of any type suitable for executing instructions. For example the processor may be a general purpose processor, an Application Specific Integrated Circuit (ASIC), a Field Programmable Gate Array (FPGA), a Complex Programmable Logic Device (CPLD), or any other such type of device. Coupled to the processor may be a firmware 114. The firmware 114 refers to the firmware image that may be utilized by the processor 112 for implementing the functionality that is provided by the first processing element. The firmware image is typically stored in non-volatile memory that is accessible to the processor 112. In some implementations, the memory may be contained entirely within the first processing element. In other implementations the memory may be external to the first processing element.

Regardless of implementation, firmware 114 represents the instructions executable by the processor to cause the processor to provide the desired functionality. For purposes of the remainder of this description, the first processing element may be referred to as a firmware directed processing element. This means that the first processing element is able to execute firmware instructions that direct the processing element to provide the desired functionality. Altering the firmware may alter the behavior of the processing element.

Second processing element 120 may be any type of processing element, just as above. The second processing element may include a Processor, ASIC, FPGA, CPLD, or any other suitable device. In some implementations, the second processing element may include a non-transitory processor readable medium containing a set of instructions 125 thereon, which when executed by a processor cause the processor to implement a firmware code signing authentication algorithm. In other implementations, the firmware code signing authentication algorithm may be implemented as circuits in hardware. Regardless of implementation, the second processing element is able to execute firmware code signing authentication algorithms in order to verify the authenticity of a firmware image.

In operation, a user may download a new firmware image 114 to the first firmware directed processing element. The firmware image may contain firmware code signing authentication information. The first processing element may be prohibited from possessing or executing the algorithms needed to authenticate the firmware image. The first processing element may send an indication of the new firmware image to the second processing element in order to delegate the authentication of the firmware image to the second processing element.

The second processing element may receive the indication from the first element. The indication may include all information needed by the second processing element to authenticate the firmware image using the firmware code singing authentication algorithm. The needed information may vary, depending on the particular algorithm that is being used. For example, some algorithms may need the entire firmware image to be sent from the first to the second processing element. Other algorithms may only need portions of the information to be sent. Regardless of the particular algorithm, the first element may send the needed authentication information to the second element as part of an authentication delegation 130.

The second processing element may then authenticate the firmware using the firmware code singing authentication algorithms in conjunction with the received information. The second processing element may be able to determine if the firmware image is authentic or not based on the algorithms. The second processing element may send an indication of the result back to the first processing element in an authentication response 140.

The authentication response may indicate that the firmware image is authentic or not authentic. If the firmware image is authentic, the first processing element may then be authorized to execute the instructions contained therein. Executing the instructions may entail simply directing the processor to execute the instructions or may entail updating the nonvolatile memory of the first processing element to store the firmware image. Regardless of implementation, the first processing element is assured that the firmware image is authentic and as such is authorized to be executed on the first processing element.

If the firmware image is not authentic, the first processing element may not execute the instructions contained therein. In some implementations, the first processing element may simply discard the non-authentic firmware, while in other implementations, the firmware image may be retained, but just not executed. The first processing element may also send an indication to the user that a firmware image download was unable to be authenticated, and as such is not being applied to the first processing element.

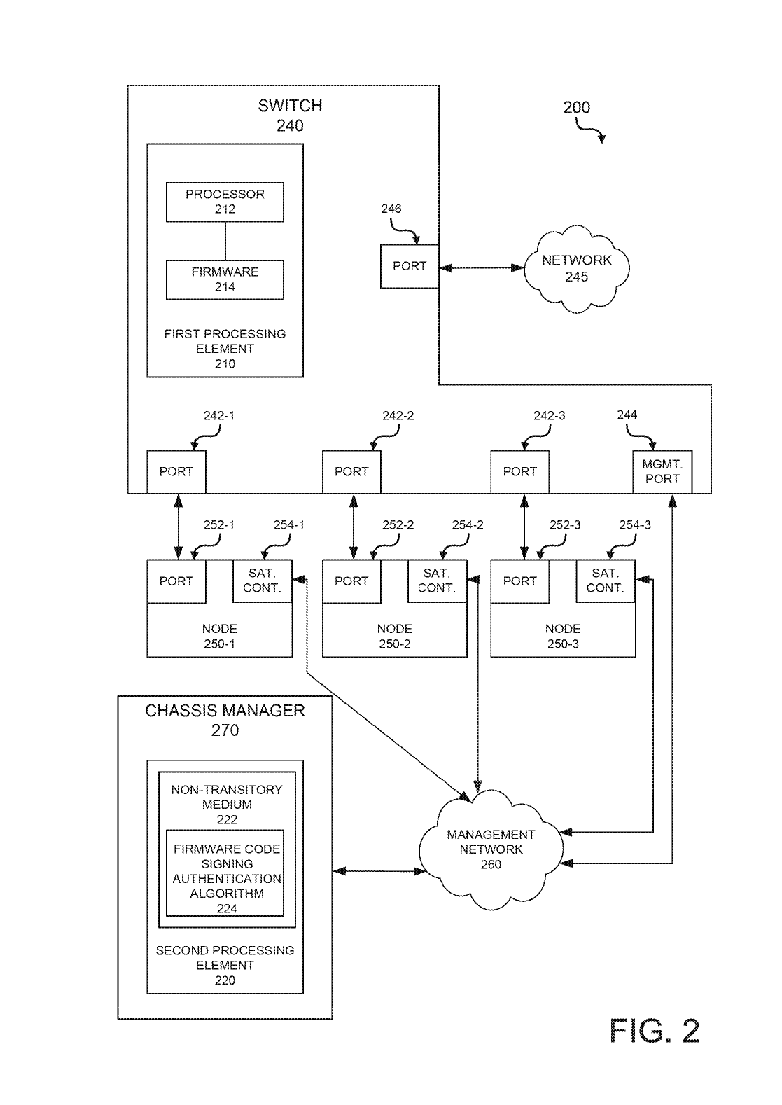

FIG. 2 is another example of a system that may utilize the firmware authentication techniques described herein. System 200 depicts a computer system with many different components. These components may be provided by different vendors. Some of the vendors may be able to execute the firmware authentication algorithms described above, while others, for whatever reason, may be prohibited from doing so.

System 200 may include a switch 240. The switch may comprise the first processing element 210, which was described in further detail in FIG. 1. The switch may include a plurality of ports 242-1, 2, 3. Although only three ports are shown, this is for purposes of simplicity of explanation, and not by way of limitation. Switch 240 may include any number of ports 242. The switch may also include a port 244 which may be connected to a management network, 260, which is described in further detail below. The switch may also include a port 246 which is connected to network 245. Network 245 may allow the switch, and devices connected to the switch, to communicate with other elements connected to the network. For example, the network 245 may be the Internet, and intranet, a private network, or any other type of network. As should be clear, switch 240 provides the normal functions of a network switch, providing connectivity between the various ports of the switch. The switch may be controlled by firmware 214, thus making the switch a firmware directed processing element. For purposes of this description, assume switch 240 is prohibited from executing the code signing authentication algorithms.

System 200 may also include a plurality of nodes 250-1, 2, 3. Once again, three nodes are shown for simplicity of explanation, and not by way of limitation. There may be any number of nodes. Each node may include a port 252-1, 2, 3 that is connected to switch 240. Thus, each node may be able to communicate with all other nodes, as well as to devices connected to network 245 through the switch. Each node may also include a satellite controller 254-1, 2, 3. The satellite controller may be used by the node for management functions. Each satellite controller may be connected to a management network 260. Also coupled to the management network may be a chassis manager 270, which is described in further detail below.

Each node may be a cartridge that fits into a chassis and provides the functionality of an individual computer. For example, each node may be in the form of a cartridge and provide one or more processors, memory, and hard drives and is capable of executing a workload. Each cartridge may plug into a chassis capable of hosting several cartridges, and providing shared resources, such as power and cooling to all the cartridges within the chassis. The switch 240 may provide connectivity between all the cartridges in the chassis and the external network 245.

Each chassis may include a chassis manager 270. The chassis manager, which may also be referred to as a baseboard management controller (BMC) may provide management functions to each node. For example, the chassis manager may communicate with the satellite controller on each node to perform functions such as powering the node up or down, configuring the node, and other such management functions. In some implementations, the BMC may also provide similar management functions to the switch 240. The chassis manager may be connected to each of the nodes and switch through the management network 260. The management network is typically separate (either physically or logically) from the network 245.

The chassis manager may include the components of the second processing element 220, which was described in further detail with respect to FIG. 1. In other words, the chassis manager may be authorized to execute the code signing authentication algorithms.

In operation, a user may download a new firmware image to switch 240. For example, the firmware image may be stored in firmware 214. The image may be downloaded from a device connect to network 245 through port 246. As explained above, switch 240 may be prohibited from executing the code signing authentication algorithms. Instead, switch 240 may send and authentication delegation to the chassis manager 270. The authentication delegation may include all the information related to the firmware image that was downloaded and is needed for authenticating the firmware image. This information may include the full firmware image or only parts of the firmware image, depending on the particular code signing authentication algorithm being used. The authentication information may be sent from the switch to the chassis manager via the management network 260.

The chassis manager 270 may then execute the firmware code singing authentication algorithm. The chassis manager may then determine if the firmware image is authentic or not. The result of the determination may be sent back to the switch 240. If the firmware is authentic, the switch may proceed to use the firmware. If the firmware is not authentic, the switch may discard the firmware. In some implementations, the switch may inform the user that the downloaded firmware was not authentic.

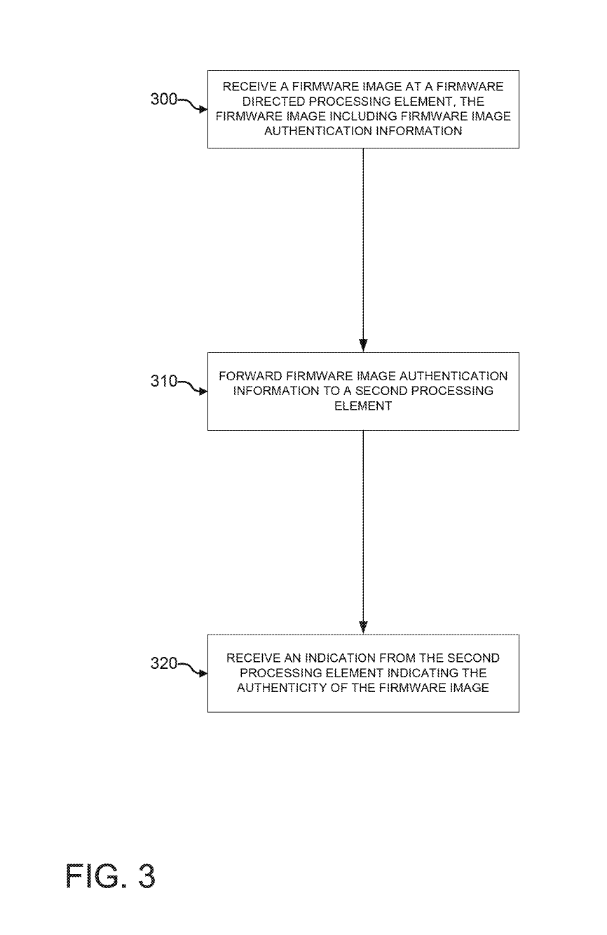

FIG. 3 is an example of a high level flow diagram for authenticating a firmware image in accordance with the techniques described herein. In block 300, a firmware image may be received at a firmware directed processing element. The firmware image may include firmware image authentication information. As explained above, the received firmware image may be the new firmware image that is to be updated on the processing element to provide new or updated functionality. This new firmware image may include authentication information, such as the code signing information discussed above, that may be used to determine if the firmware is authentic.

In block 310, the firmware image authentication information may be forwarded to a second processing element. As explained above, the second processing element may be a general purpose processor or it may be a function specific processor. For example, the processor may be a baseboard management controller. In some implementations, the baseboard management controller may be a chassis manager controller.

In block 320, an indication may be received from the second processing element. The indication may indicate the authenticity of the firmware image. As explained above, the second processing element may receive the authentication information from the firmware directed processing element. The second processing element may determine if the firmware is authentic. The second processing element may then return an indication to the firmware directed processing element, indicating if the firmware is authentic.

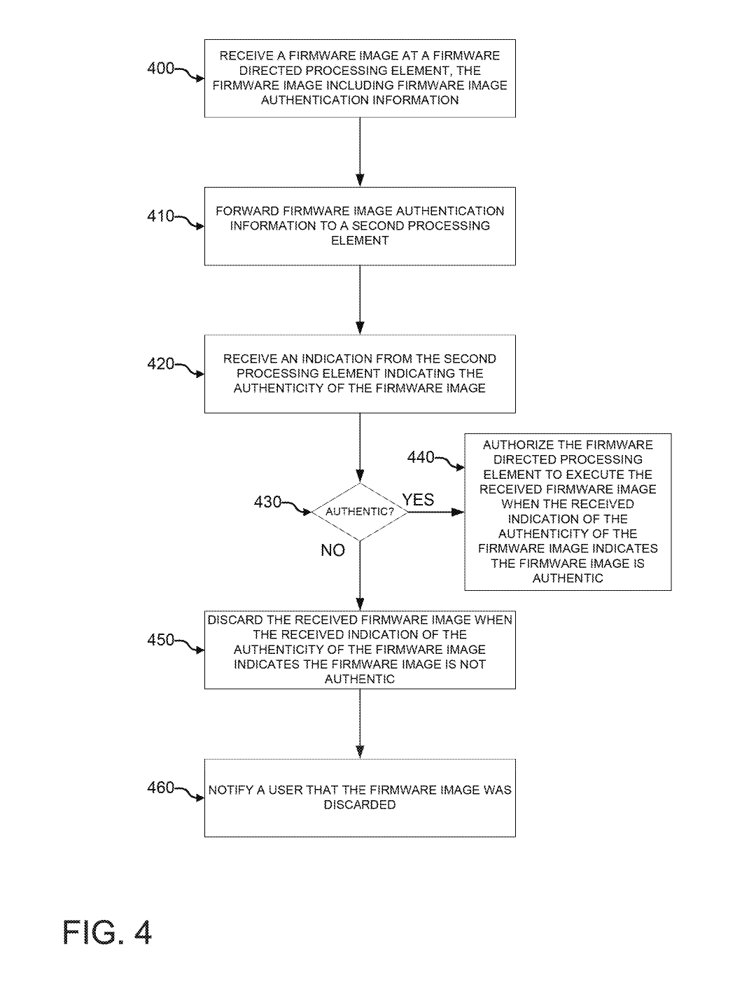

FIG. 4 is another example of a high level flow diagram for authenticating a firmware image in accordance with the techniques described herein. In block 400, just as above, a firmware image may be received at a firmware directed processing element. In block 410, as above, the firmware image authentication information may be forwarded to a second processing element. In block 420, as above, an indication may be received from the second processing element, indicating if the firmware is authentic.

In block 430 it may be determined if the indication from the second processing element indicates the firmware is authentic. If so, the process moves to block 440. In block 440, the firmware directed processing element may be authorized to execute the received firmware image when the received indication of the authenticity of the firmware image indicates the image is authentic. In other words, the firmware directed processing element is able to update itself with the new firmware image. If the indication indicate the firmware image is not authentic, the process may move to block 450.

In block 450, the received firmware image may be discarded when the received indication of the authenticity of the firmware image indicates that the firmware image is not authentic. In other words, because the firmware image cannot be authenticated, there is no way to ensure that the firmware image has not been modified in some unknown, possibly malicious, way. As such, the firmware image may simply be discarded rather than take the risk of updating with unauthenticated firmware. In block 460, a user may be notified that the firmware image was discarded. The notification may prompt the user to determine the source of the unauthenticated firmware or to take some other corrective action.

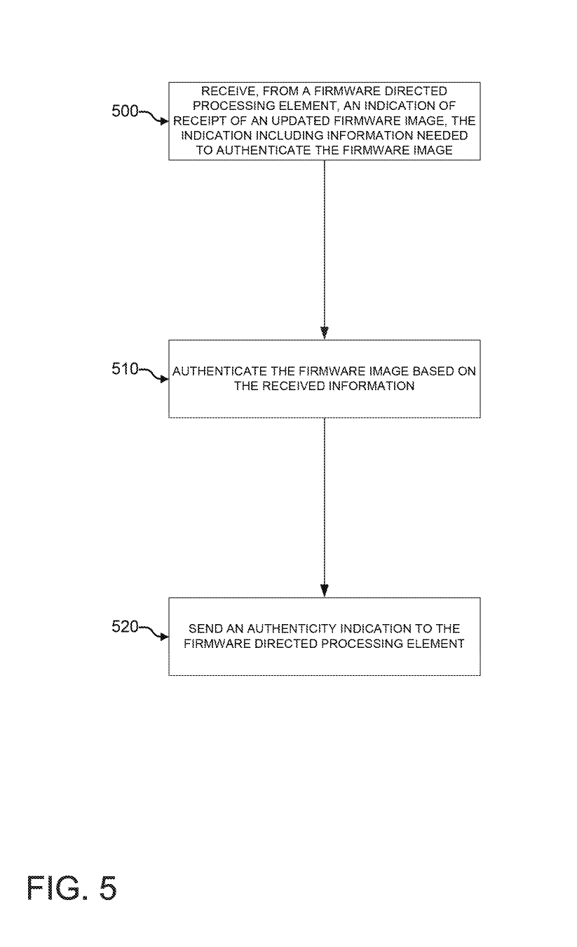

FIG. 5 is an example of a high level flow diagram for authenticating a firmware image according to techniques described herein. In block 500, an indication of receipt of an updated firmware image may be received from a firmware directed processing element. The indication may include information needed to authenticate the firmware image. In other words, a processor, such as a baseboard management controller or a chassis controller, may receive an indication from a firmware directed processing element, such as a network switch, that the firmware directed processing element has received a firmware image.

In block 510, the firmware image may be authenticated based on the received information. In other words, the firmware directed processing element may send the information needed to authenticate the firmware image to the processor. The processor may then authenticate the firmware image. In block 520, and authenticity indication may be sent to the firmware directed processing element. In other words, the result of the authentication process may be sent to the firmware directed processing element. The element may then decide the proper course of action, based on if the firmware is authentic or not.

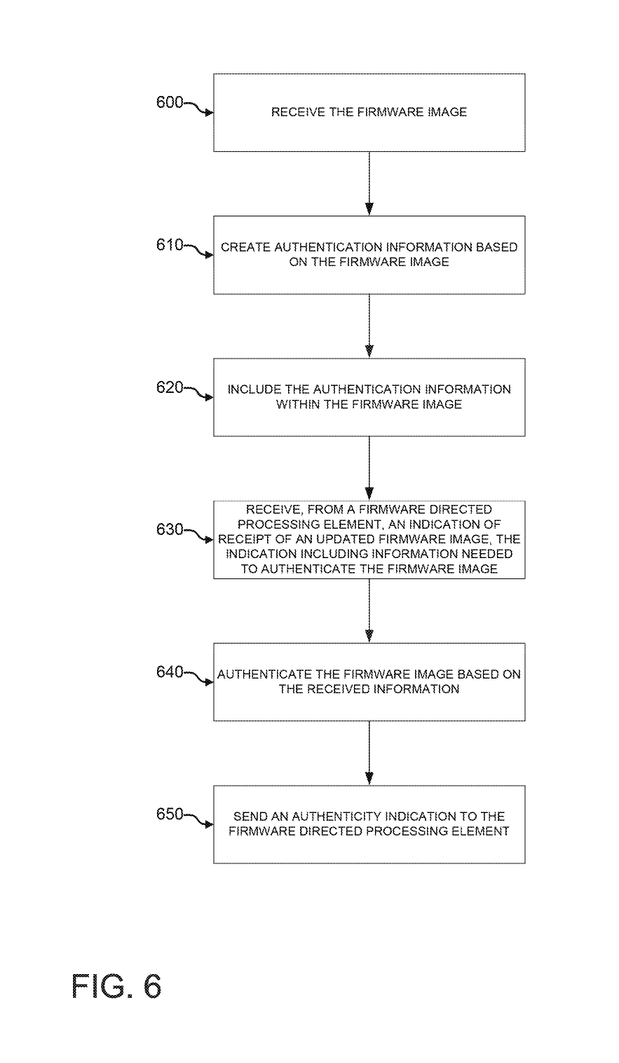

FIG. 6 is another example of a high level flow diagram for authenticating a firmware image according to techniques described herein. In block 600, a firmware image may be received. For example, as explained above, the firmware image may be received from a vendor of a device that is prohibited from running the authentication process. In block 610, authentication information based on the firmware image may be created. In block 620, the created authentication information may be included in the firmware image. In other words, the code signing process described above may be executed on the new firmware image. Because this process is not done by the entity that is prohibited from accessing the code signing algorithms, there is no issue with violating the prohibition. It should be understood that blocks 600-620 may be executed well in advance of the remaining steps.

In block 630, just as above, an indication of receipt of an updated firmware image may be received form a firmware directed processing element. In block 640, just as above, the firmware image may be authenticated based on the received information. In block 650, as above, an indication of the firmware authenticity may be sent to the firmware directed processing element.

We claim:

1. A system comprising:
a first firmware directed processing element, the first firmware directed processing element not including a firmware code signing authentication algorithm;
a second processing element, the second processing element including the firmware code signing authentication algorithm;
wherein the first processing element delegates firmware code authentication to the second processing element.

2. The system of claim 1 wherein the firmware code authentication algorithm is implemented as executable instructions on the second processing element.

3. The system of claim 1 wherein the firmware code authentication algorithm is implemented in hardware on the second processing element.

4. The system of claim 1 further comprising:
the first firmware directed processing element providing network switch functionality; and
the second processing element providing baseboard management controller functionality.

5. The system of claim 1 wherein inclusion of the code singing authentication algorithm on the first firmware directed processing element is prohibited.

6. A method comprising:
receiving a firmware image at a firmware directed processing element, the firmware image including firmware image authentication information;
forwarding firmware image authentication information to a second processing element; and
receiving an indication from the second processing element indicating the authenticity of the firmware image.

7. The method of claim 1 further comprising:
discarding the received firmware image when the received indication of the authenticity of the firmware image indicates the firmware image is not authentic.

8. The method of claim 1 further comprising:
authorizing the firmware directed processing element to execute the received firmware image when the received indication of the authenticity of the firmware image indicates the firmware image is authentic.

9. The method of claim 1 wherein the firmware directed processing element is prohibited from authenticating the received firmware image.

10. The method of claim 7 further comprising:
notifying a user that the firmware image was discarded.

11. A non-transitory processor readable medium containing thereon a set of instructions, which when executed by a processor cause the processor to:
receive, from a firmware directed processing element, an indication of receipt of an updated firmware image, the indication including information needed to authenticate the firmware image;
authenticate the firmware image based on the received information; and
send an authenticity indication to the firmware directed processing element.

12. The medium of claim 11 wherein the processor is a baseboard management controller and the firmware directed processing element is a network switch.

13. The medium of claim 11 further comprising instructions to:
receive the firmware image;
create authentication information based on the firmware image; and
include the authentication information within the firmware image.

14. The medium of claim 11 wherein the algorithm to authenticate the firmware image cannot be executed on the firmware directed processing element.

15. The medium of claim 11 wherein the processor is a chassis manager.
